(19) United States
(12) Patent Application Publication
(10) Pub. No.: US 2026/0269706 A1
(43) Pub. Date: Sep. 10, 2026

(54) POWER CONVERTER

(71) Applicant: Delta Electronics, Inc., Taoyuan City (TW)

(72) Inventors: Ke Sun, Shanghai (CN); Shaopeng Han, Shanghai (CN); Yanbing Xia, Shanghai (CN)

(21) Appl. No.: 19/319,621

(22) Filed: Sep. 4, 2025

(30) Foreign Application Priority Data
Mar. 5, 2025 (CN) 202510258339.X

(51) Int. Cl. H02M 1/00; H02M 3/335

(52) U.S. Cl. CPC H02M 1/0048; H02M 3/33576

(57) ABSTRACT

A power converter is provided. When any one of the conversion units of the power converter starts up, the first switching element is turned off and the second switching element is turned on. Consequently, the input voltage is provided to the auxiliary power supply through the linear regulator and the second switching element. When the voltage across the input capacitor within the conversion unit reaches dynamic equilibrium so as to reach a steady-state condition, the second switching element is turned off and the first switching element is turned on. The conversion unit is served as an energy source to provide power to the auxiliary power supply through the first switching element. The power converter utilizes the components within the conversion unit to provide power during the steady-state condition. The power loss of the linear regulator is reduced, and the overall stability of the power converter is improved.

### CROSS-REFERENCE TO RELATED APPLICATION

This application claims the priority to China Patent Application No. 202510258339.X, filed on Mar. 05, 2025, the entirety of which is hereby incorporated by reference.

### FIELD OF THE INVENTION

The present disclosure relates to power conversion, and more particularly to a power converter.

### BACKGROUND OF THE INVENTION

With the continuous expansion of data center scale and the development of artificial intelligence technology, the power demand of each rack has risen sharply. To meet the power requirement of the rack, server power supplies are evolved toward higher power, improved efficiency, and more compact form factors. Power converters are now receiving an increasing variety of bus input voltage levels. In addition to the traditional 48V, multiple different voltage levels have been introduced.

To meet the requirements of increasing rack power and diversified bus input voltages, the power converter includes a plurality of conversion units and an auxiliary power supply. The plurality of conversion units can be connected in series or in parallel. Each conversion unit includes an input port and an output port. Each conversion unit receives the bus input voltage through the input port and outputs an output voltage through the output port. The auxiliary power supply provides power to additional logic control circuits. In the conventional power converter, the auxiliary power supply receives the bus input voltage by utilizing two methods. In the first method, the auxiliary power supply is directly connected with the bus input voltage. However, to meet the input voltage requirements, this results in a larger auxiliary power supply size and higher stress levels, ultimately increasing the overall size and stress of the power converter. In the second method, a linear regulator is disposed in the power converter. The linear regulator is connected between the bus input voltage and the auxiliary power supply. The linear regulator steps down the bus voltage before providing power to the auxiliary power supply. However, the power loss in the linear regulator is determined by the voltage drop between the input port and output port multiplied by the current passing through the linear regulator. Consequently, when the bus voltage is in a steady-state condition and the load is increased, the current through the linear regulator is increased. The power loss and the failure rate of the linear regulator is increased. The overall reliability of the power converter is reduced.

Therefore, there is a need of providing a power converter to obviate the drawbacks encountered from the prior arts.

### SUMMARY OF THE INVENTION

The present disclosure provides a power converter. when any one of the conversion units of the power converter of the present disclosure starts up, the first switching element is turned off and the second switching element is turned on. Consequently, the input voltage is provided to the auxiliary power supply through the linear regulator and the second switching element. When the voltage across the input capacitor within the conversion unit reaches dynamic equilibrium so as to reach a steady-state condition, the second switching element is turned off and the first switching element is turned on. Consequently, at least one of the conversion units is served as an energy source to provide power to the auxiliary power supply through the first switching element. The power converter of the present disclosure utilizes the components within the conversion unit to provide power during the steady-state condition. Consequently, the power loss of the linear regulator is reduced, and the overall stability of the power converter is improved.

In accordance with an aspect of the present disclosure, a power converter is provided. The power converter includes an input port, an output port, a plurality of conversion units, an auxiliary power supply, a linear regulator, a first switching element and a second switching element. The power converter is configured to receive an input voltage through the input port and output an output voltage through the output port. Each of the plurality of conversion units includes a sub input port, a sub output port and an input capacitor. The sub input port of each of the plurality of conversion units is connected with the input port to receive the input voltage. The sub output port of each of the plurality of conversion units is connected with the output port. The input capacitor of each of the plurality of conversion units is connected with the corresponding sub input port of the conversion unit. The linear regulator is connected with the input port. The linear regulator steps down the input voltage when the input voltage is received. The first switching element is connected between at least one of the plurality of conversion units and the auxiliary power supply. The second switching element is connected between the linear regulator and the auxiliary power supply. When any one of the plurality of conversion units starts up, the first switching element is turned off and the second switching element is turned on. The input voltage is provided to the auxiliary power supply through the linear regulator and the second switching element. When a voltage across the input capacitor reaches dynamic equilibrium, the second switching element is turned off and the first switching element is turned on. At least one of the plurality of conversion units is served as an energy source so as to provide power to the auxiliary power supply through the first switching element.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating a power converter according to a first embodiment of the present disclosure;

FIG. 2 is a schematic circuit diagram illustrating a power converter according to a second embodiment of the present disclosure;

FIG. 3 is a schematic circuit diagram illustrating a power converter according to a third embodiment of the present disclosure;

FIG. 4 is a schematic circuit diagram illustrating a power converter according to a fourth embodiment of the present disclosure;

FIG. 5 is a schematic circuit diagram illustrating a power converter according to a fifth embodiment of the present disclosure;

FIG. 6 is a schematic circuit diagram illustrating a power converter according to a sixth embodiment of the present disclosure; and

FIG. 7 is a schematic circuit diagram illustrating a power converter according to a seventh embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

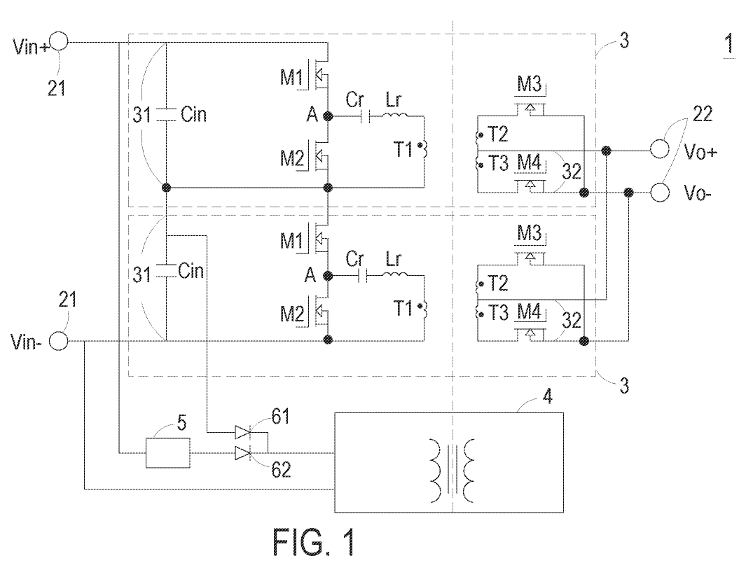

FIG. 1 is a schematic circuit diagram illustrating a power converter according to a first embodiment of the present disclosure. As shown in FIG. 1, the power converter 1 includes an input port 21, an output port 22, a plurality of conversion units 3, an auxiliary power supply 4, a linear regulator 5, a first switching element 61 and a second switching element 62. The power converter 1 receives an input voltage through the input port 21 and outputs an output voltage through the output port 22. The power converter 1 of this embodiment includes two conversion units 3. Certainly, the number of conversion units 3 may be adjusted according to the requirement. Each conversion unit 3 is but not limited to a resonant converter, a full-bridge circuit or a flyback converter. Each conversion unit 3 includes a sub input port 31, a sub output port 32 and an input capacitor Cin. The sub input port 31 of each conversion unit 3 is connected with the input port 21 of the power converter 1. In this embodiment, the sub input ports 31 of the two conversion units 3 are connected in series and connected with the input port 21 of the power converter 1. The sub output port 32 of each conversion unit 3 is connected with the output port 22 of the power converter 1. In this embodiment, the sub output ports 32 of the two conversion units 3 are connected in parallel and connected with the output port 22 of the power converter 1. The input capacitor Cin of each conversion unit 3 is connected with the corresponding sub input port 31 of the conversion unit 3.

The auxiliary power supply 4 is connected with the input negative terminal of the input port 21 of the power converter 1 and the logic control circuit (not shown) of the power converter 1 to provide the logic control circuit. The linear regulator 5 is but not limited to a low dropout linear regulator and connected with the input positive terminal of the input port 21 of the power converter 1 so as to step down the input voltage when the input voltage is received. The first switching element 61 is a diode and connected between the second conversion unit 3 and the auxiliary power supply 4. The anode of the first switching element 61 is connected with the input capacitor Cin of the corresponding conversion unit 3. The cathode of the first switching element 61 is connected with the auxiliary power supply 4. When the voltage across the input capacitor Cin of the second conversion unit 3 is greater than the output voltage of the linear regulator 5, the first switching element 61 is turned on. Consequently, the voltage of the input capacitor Cin of the second conversion unit 3 is transmitted to the first switching element 61 and supplied to the auxiliary power supply 4. The second switching element 62 is a diode and connected between the linear regulator 5 and the auxiliary power supply 4. The anode of the second switching element 62 is connected with the linear regulator 5. The cathode of the second switching element 62 is connected with the auxiliary power supply 4. When the output voltage of the linear regulator 5 (i.e., the voltage at the port connected with one port of the second switching element 62) is greater than the voltage across the input capacitor Cin of the second conversion unit 3, the second switching element 62 is turned on. Consequently, the voltage outputted from the linear regulator 5 is supplied to the auxiliary power supply 4.

When any one of the conversion units 3 starts up, an input source (not shown) provides an input voltage Vin to charge the input capacitor Cin within the conversion unit 3. Simultaneously, the linear regulator 5 steps down the input voltage. The output voltage of the linear regulator 5 is greater than the voltage across the input capacitor Cin of the second conversion unit 3. Consequently, the first switching element 61 is turned off and the second switching element 62 is turned on. The input voltage is provided to the auxiliary power supply 4 through the linear regulator 5 and the second switching element 62. When the input source charges the input capacitor Cin within the conversion unit 3 and the voltage across the input capacitor Cin reaches dynamic equilibrium so as to reach a steady-state condition, the voltage across the input capacitor Cin is greater than the output voltage of the linear regulator 5. Consequently, the second switching element 62 is turned off and the first switching element 61 is turned on. At least one conversion unit 3 is served as an energy source so as to provide power to the auxiliary power supply 4 through the first switching element 61. In this embodiment, the first switching element 61 is connected with the input capacitor Cin of the second conversion unit 3. Consequently, the voltage across the input capacitor Cin of the second conversion unit 3 is serves as an energy source to be provided to the auxiliary power supply 4 through the first switching element 61. Number of the plurality of conversion units 3 is N, the input capacitors of M conversion units 3 of the N conversion units 3 are connected in parallel to serve as the energy source, wherein 1≤M<N.

From above, when any one of the conversion units 3 of the power converter 1 of the present disclosure starts up, the first switching element 61 is turned off and the second switching element 62 is turned on. Consequently, the input voltage is provided to the auxiliary power supply 4 through the linear regulator 5 and the second switching element 62. When the voltage across the input capacitor Cin within the conversion unit 3 reaches dynamic equilibrium so as to reach a steady-state condition, the second switching element 62 is turned off and the first switching element 61 is turned on. Consequently, at least one of the conversion units 3 is served as an energy source to provide power to the auxiliary power supply 4 through the first switching element 61. The conventional power converter steps down the input voltage both the startup condition and the steady-state condition through the linear regulator. Compared with the conventional power converter, the power converter 1 of the present disclosure utilizes the components within the conversion unit 3 to provide power during the steady-state condition. Consequently, the power loss of the linear regulator 5 is reduced, and the overall stability of the power converter 1 is improved.

Please refer to FIG. 1 again. Each conversion unit 3 of the power converter 1 of this embodiment further includes a first switch M1, a second switch M2, a resonant capacitor Cr, a resonant inductor Lr, a primary winding T1, a first secondary winding T2, a second secondary winding T3, a third switch M3 and a fourth switch M4. The first switch M1 and the second switch M2 are connected in series and connected in parallel with the input capacitor Cin. The first switch M1 and the second switch M2 are connected with a node A. The resonant capacitor Cr, the resonant inductor Lr and the primary winding T1 are connected in series between the node A and one end of the input capacitor Cin. The first secondary winding T2 and the second secondary winding T3 are connected in series and coupled with the primary winding T1, respectively. The node connecting the first secondary winding T2 and the second secondary winding T3 is connected with the output positive terminal of the sub output port 32. Consequently, a center-tap structure is formed. The third switch M3 is connected between the first secondary winding T2 and the output negative terminal of the sub output port 32. The fourth switch M4 is connected between the second secondary winding T3 and the output negative terminal of the sub output port 32. In this embodiment, the primary winding T1, the first secondary winding T2 and the second secondary winding T3 are formed as a transformer, collaboratively.

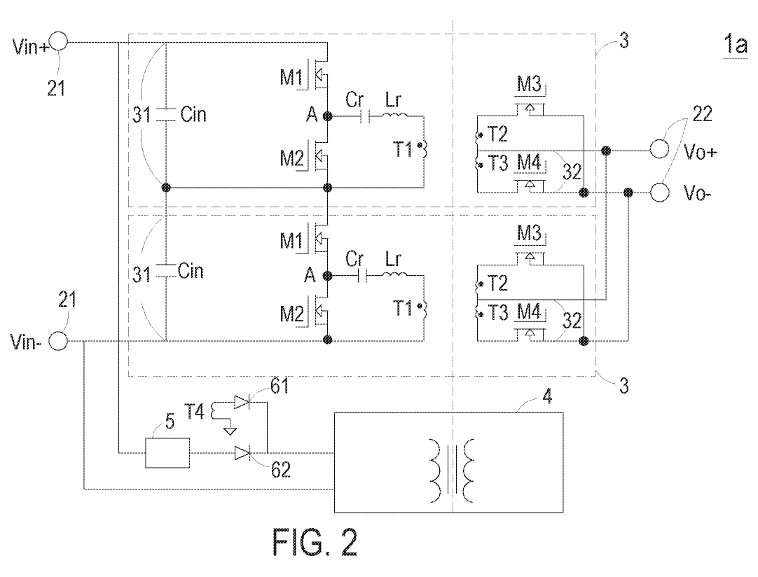

FIG. 2 is a schematic circuit diagram illustrating a power converter according to a second embodiment of the present disclosure. As shown in FIG. 2, the power converter 1a of this embodiment is similar to the power converter 1 of FIG. 1. The first switching element 61 of the power converter 1 of FIG. 1 is connected with the input capacitor Cin of the conversion unit 3. Compared to the power converter 1 of FIG. 1, the power converter 1a of this embodiment includes an auxiliary winding T4. The auxiliary winding T4 is coupled with the primary winding T1, the first secondary winding T2 and the second secondary winding T3 of at least one of the two conversion units 3. In this configuration, the first switching element 61 is connected between the auxiliary winding T4 and the auxiliary power supply 4.

In this embodiment, when any one of the conversion units 3 starts up, the linear regulator 5 steps down the input voltage simultaneously. The output voltage of the linear regulator 5 is greater than the voltage across the auxiliary winding T4. Consequently, the first switching element 61 is turned off and the second switching element 62 is turned on. The input voltage is provided to the auxiliary power supply 4 through the linear regulator 5 and the second switching element 62. When the voltage across the input capacitor Cin in the conversion unit 3 reaches dynamic equilibrium so as to reach a steady-state condition, the voltage across the winding coupled with the auxiliary winding T4 is greater than the output voltage of the linear regulator 5. Consequently, the second switching element 62 is turned off and the first switching element 61 is turned on. The winding coupled with the auxiliary winding T4 is served as an energy source to provide power to the auxiliary power supply 4 through the first switching element 61. In some embodiments, the number of auxiliary windings T4 is more than one. The auxiliary windings T4 can be coupled with a plurality of windings. The plurality of windings coupled with the auxiliary winding T4 are served as energy sources, and are not redundantly described hereinafter. In some embodiments, the power converter comprises a plurality of auxiliary windings. The plurality of auxiliary windings are coupled with the plurality of windings of at least one of the plurality of conversion units.

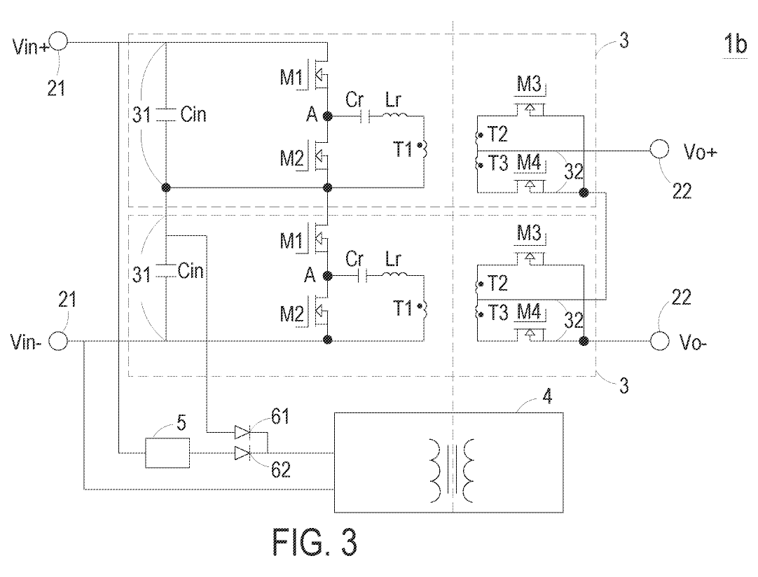

In practical requirement, the gain, the winding ratio or the structure of each conversion unit 3 may not be exactly the same. The connection relationship between the sub input ports and sub output ports of the plurality of conversion units 3 can be adjusted according to requirement for accommodating the input voltage received by the power converter flexibly. FIG. 3 is a schematic circuit diagram illustrating a power converter according to a third embodiment of the present disclosure. As shown in FIG. 3, the power converter 1b of this embodiment is similar to the power converter 1of FIG. 1. The sub output ports 32 of the two conversion units 3 of the power converter 1 of FIG. 1 are connected in parallel. Compared to the power converter 1 in FIG. 1, the sub output ports 32 of the two conversion units 3 of the power converter 1b of this embodiment are connected in series. Consequently, the output current of the power converter 1b is enhanced.

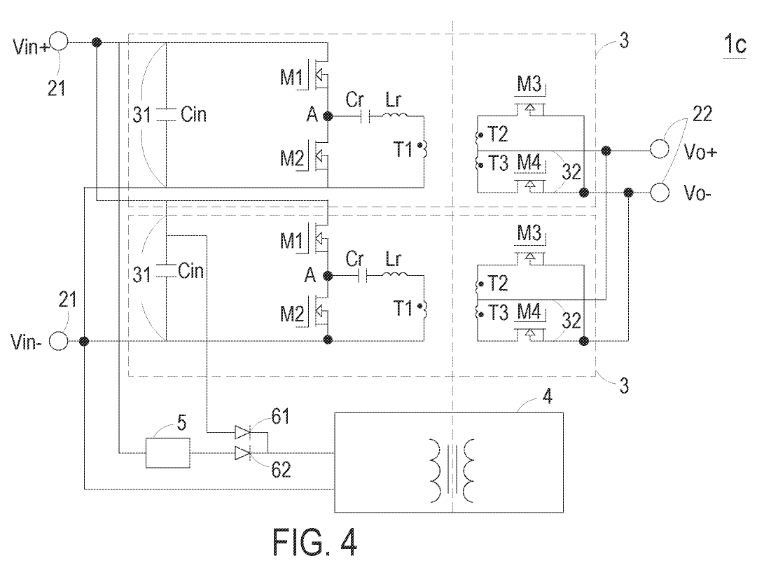

FIG. 4 is a schematic circuit diagram illustrating a power converter according to a fourth embodiment of the present disclosure. As shown in FIG. 4, the power converter 1c of this embodiment is similar to the power converter 1 of FIG. 1. The sub input ports 31 of the two conversion units 3 of the power converter 1 of FIG. 1 are connected in series. Compared to the power converter 1 of FIG. 1, the sub input ports 31 of the two conversion units 3 of the power converter 1c of this embodiment are connected in parallel.

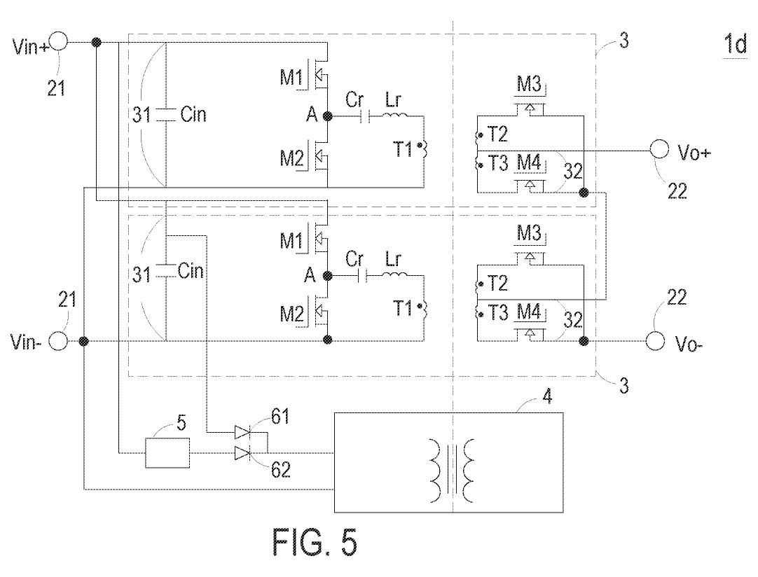

FIG. 5 is a schematic circuit diagram illustrating a power converter according to a fifth embodiment of the present disclosure. As shown in FIG. 5, the power converter 1d of this embodiment is similar to the power converter 1 of FIG. 1. The sub input ports 31 of the two conversion units 3 of the power converter 1 of FIG. 1 are connected in series. The sub output ports 32 of the two conversion units 3 of the power converter 1 of FIG. 1 are connected in parallel. Compared to the power converter 1 of FIG. 1, the sub input ports 31 of the two conversion units 3 of the power converter 1d of this embodiment are connected in parallel. The sub output ports 32 of the two conversion units 3 of the power converter 1d of this embodiment are connected in series.

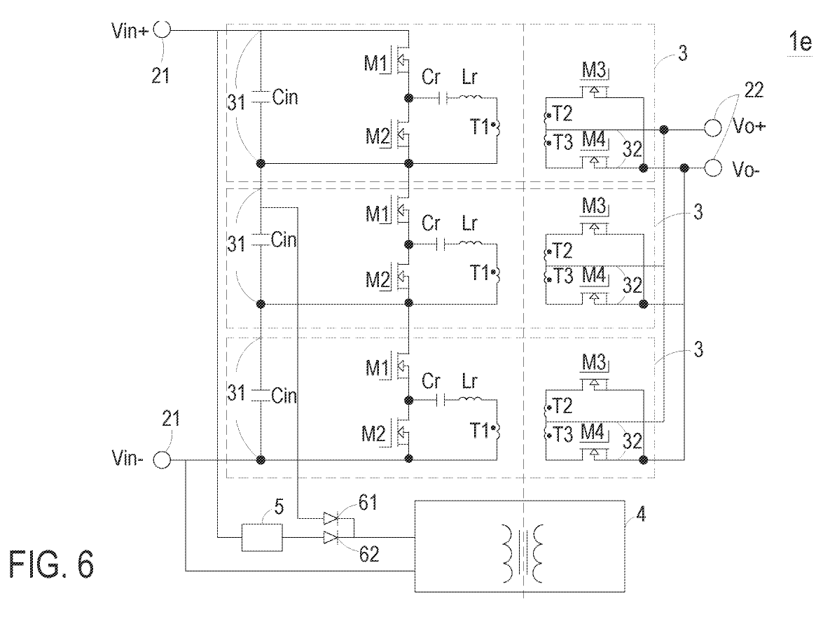

In some embodiments, the number of conversion units of the power converter may be more than two. FIG. 6 is a schematic circuit diagram illustrating a power converter according to a sixth embodiment of the present disclosure. As shown in FIG. 6, the power converter 1e of this embodiment is similar to the power converter 1 of FIG. 1. The power converter 1 of FIG. 1 includes two conversion units 3. Compared to the power converter 1 of FIG. 1, the power converter 1e of this embodiment includes three conversion units 3. The sub input ports 31 of the three conversion units 3 are connected in series in sequence. The sub output ports 32 of the three conversion units 3 are connected in parallel. In this embodiment, the first switching element 61 is connected with the input capacitor Cin of the second conversion unit 3. Consequently, the voltage across the input capacitor Cin of the second conversion unit 3 and the voltage across the input capacitor Cin of the third conversion unit 3 are combined to be served as the energy source to provide power to the auxiliary power supply 4 through the first switching element 61.

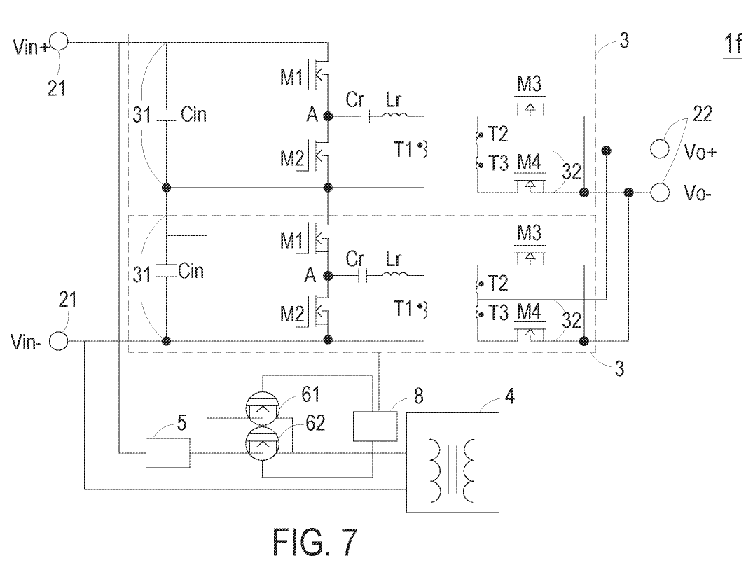

In some embodiments, the first switching element and the second switching element can be implemented not only as diodes, but also as switching transistors. FIG. 7 is a schematic circuit diagram illustrating a power converter according to a seventh embodiment of the present disclosure. As shown in FIG. 7, the power converter 1f of the present embodiment is similar to the power converter 1 of FIG. 1. The first switching element and the second switching element of the power converter 1 of FIG. 1 are diodes. Compared to the power converter 1 of FIG. 1, the first switching element 61 and the second switching element 62 of the power converter 1f of this embodiment are switching transistors. The power converter 1f of this embodiment further includes a control module 8. The control module 8 is connected with the two conversion units 3, the first switching element 61 and the second switching element 62. The control module 8 is configured to turn off the first switching element 61 and turn on the second switching element 62 when the control module 8 detects that any one of the conversion units 3 starts up. The control module 8 is configured to turn off the second switching element 62 and turn on the first switching element 61 when the control module 8 detects that the voltage across the input capacitor Cin of at least one of the conversion units 3 reaches dynamic equilibrium. Certainly, the first switching element 61 and the second switching element 62 can also be implemented by any electronic device capable of switching between a short-circuit state and an open-circuit state. In some embodiments, the control module 8 may be configured to control only the first switching element 61 and the second switching element 62, but not control the switches within the conversion units.

As mentioned above, when any one of the conversion units of the power converter of the present disclosure starts up, the first switching element is turned off and the second switching element is turned on. Consequently, the input voltage is provided to the auxiliary power supply through the linear regulator and the second switching element. When the voltage across the input capacitor within the conversion unit reaches dynamic equilibrium so as to reach a steady-state condition, the second switching element is turned off and the first switching element is turned on. Consequently, at least one of the conversion units is served as an energy source to provide power to the auxiliary power supply through the first switching element. The power converter of the present disclosure utilizes the components within the conversion unit to provide power during the steady-state condition. Consequently, the power loss of the linear regulator is reduced, and the overall stability of the power converter is improved.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power converter, comprising:
an input port and an output port, wherein the power converter is configured to receive an input voltage through the input port and output an output voltage through the output port;
a plurality of conversion units, wherein each of the plurality of conversion units comprises a sub input port, a sub output port and an input capacitor, the sub input port of each of the plurality of conversion units is connected with the input port to receive the input voltage, the sub output port of each of the plurality of conversion units is connected with the output port, and the input capacitor of each of the plurality of conversion units is connected with the corresponding sub input port of the conversion unit;
an auxiliary power supply;
a linear regulator connected with the input port, wherein the linear regulator steps down the input voltage when the input voltage is received;
a first switching element connected between at least one of the plurality of conversion units and the auxiliary power supply; and
a second switching element connected between the linear regulator and the auxiliary power supply;
wherein when any one of the plurality of conversion units starts up, the first switching element is turned off and the second switching element is turned on, and the input voltage is provided to the auxiliary power supply through the linear regulator and the second switching element; when a voltage across the input capacitor reaches dynamic equilibrium, the second switching element is turned off and the first switching element is turned on, and at least one of the plurality of conversion units is served as an energy source so as to provide power to the auxiliary power supply through the first switching element.

2. The power converter according to claim 1, wherein number of the plurality of conversion units is N, the input capacitors of M conversion units of the N conversion units are connected in parallel to serve as the energy source, wherein 1≤M<N.

3. The power converter according to claim 1, wherein each of the plurality of conversion units comprises a transformer, and the transformer comprises a plurality of windings.

4. The power converter according to claim 3, wherein the power converter comprises an auxiliary winding, the auxiliary winding is coupled with the plurality of windings of at least one of the plurality of conversion units, the first switching element is connected between the auxiliary winding and the auxiliary power supply, and the plurality of windings coupled with the auxiliary winding are served as the energy source.

5. The power converter according to claim 3, wherein the power converter comprises a plurality of auxiliary windings, the plurality of auxiliary windings are coupled with the plurality of windings of at least one of the plurality of conversion units, the first switching element is connected between the plurality of auxiliary windings and the auxiliary power supply, and the plurality of windings coupled with the auxiliary winding are served as the energy source.

6. The power converter according to claim 1, wherein the first switching element and the second switching element are diodes, respectively, wherein when a voltage across the input capacitor of at least one of the plurality of conversion units reaches dynamic equilibrium, the second switching element is turned off and the first switching element is turned on.

7. The power converter according to claim 1, wherein the first switching element and the second switching element are switching transistors, wherein the power converter comprises a control module, the control module is connected with the plurality of conversion units, the first switching element and the second switching element, the control module is configured to turn off the first switching element and turn on the second switching element when the control module detects that any one of the plurality of conversion units starts up, and the control module is configured to turn off the second switching element and turn on the first switching element, when the control module detects that a voltage across the input capacitor of at least one of the plurality of conversion units reaches dynamic equilibrium.

8. The power converter according to claim 1, wherein the sub input ports of the plurality of conversion units of the power converter are connected in series, and the sub output ports of the plurality of conversion units of the power converter are connected in series.

9. The power converter according to claim 1, wherein the sub input ports of the plurality of conversion units of the power converter are connected in parallel, and the sub output ports of the plurality of conversion units of the power converter are connected in parallel.

10. The power converter according to claim 1, wherein the sub input ports of the plurality of conversion units of the power converter are connected in series, and the sub output ports of the plurality of conversion units of the power converter are connected in parallel.

11. The power converter according to claim 1, wherein the sub input ports of the plurality of conversion units of the power converter are connected in parallel, and the sub output ports of the plurality of conversion units of the power converter are connected in series.

12. The power converter according to claim 1, wherein each of the plurality of conversion units is a resonant converter, a full-bridge circuit or a flyback converter.
